(19) United States
(12) Patent Application Publication
(10) Pub. No.: US 2006/0230091 A1
(43) Pub. Date: Oct. 12, 2006

(54) Method and apparatus for compressing image data

(75) Inventor: Miyako Minobe, Kanagawa-Ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/396,456

(22) Filed: Apr. 4, 2006

(30) Foreign Application Priority Data
Apr. 6, 2005 (JP) 2005-110190

(51) Int. Cl. G06F 17/14

(52) U.S. Cl. 708/400

(57) ABSTRACT

The present invention provides a method of compressing image data. The method includes a step of transforming image data into data composed of frequency components. In the transforming step, a number of bits calculated for frequency components requiring relatively low calculation quality for a transforming process is reduced below a number of bits calculated for frequency components requiring relatively high calculation quality for the transforming process. The present invention increases calculation speed while suppressing the degradation of image quality.

### FIELD OF THE INVENTION

The present invention relates to a method and apparatus for compressing image data.

### BACKGROUND OF THE INVENTION

Data on images taken with a camera, video, or scanner is compressed to reduce the data amount before being stored or communicated. A typical compressing process is a technique consisting of orthogonal transformation, quantization, and entropy encoding.

FIG. 11 is a diagram showing an example of general configuration of a compressing process in conformity with a JPEG baseline process.

Input image data divided into blocks each composed of 8×8 pixels is sent to an orthogonal transformer 72 by an input device 71; the orthogonal transformer 72 follows the input device 71 in the circuit.

The orthogonal transformer 72 executes a discrete cosine transformation (DCT) to transform two-dimensional space data into two-dimensional frequency data to output 8×8=64 DCT coefficients.

In a two-dimensional DCT process, input image data sent by the input device 71 is space data in which pixels are distributed in an 8×8 two-dimensional space. A one-dimensional discrete cosine transformation is then executed on each row of the 8×8 block to obtain horizontal frequency transformation results. These intermediate results are used to execute a one-dimensional discrete cosine transformation on each column of the 8×8 block, that is, a vertical frequency transformation, to obtain two-dimensional DCT coefficients. If such a one-dimensional discrete cosine transformation is repeated, the results remain unchanged even if the transformation of the rows is executed after the transformation of the columns.

One of the resulting DCT coefficients which is located in the upper left corner of the block is a direct current (DC) component, while the remaining 63 coefficients are called alternating current (AC) components.

The DCT coefficients output by the orthogonal transformer 72 are linearly quantized by a quantizer 73 using a quantization table 75 for which quantization steps (intervals) are set. The DCT coefficients are further compressed by an entropy encoder 74 using an encoding table 76.

However, the conventional image encoding process is disadvantageous in that since the number of bits used for calculation is fixed, calculation quality and processing time cannot be sufficiently freely varied.

A method is known which enables the calculation quality and processing time of image encoding to be varied as required in order to solve this problem (Japanese Patent Application Laid-Open No. 6-205222 (Patent Document 1)).

Patent Document 1 describes an image compressing method of controlling the quality by a bit length control process of controlling the bit length of image data to be orthogonally transformed, in association with a bit length resulting from calculation (FIG. 12).

As in the case of the above conventional compressing process, input image data formed into an 8×8 block is sent to an orthogonal transformer 82 by an input device 81; the orthogonal transformer 82 follows the input device 81 in the circuit.

The orthogonal transformer 82 executes a two-dimensional discrete cosine transforming process to output 8×8=64 DCT coefficients. The two-dimensional discrete cosine transforming process involves a vertical discrete cosine transformation executed on the result of a horizontal discrete cosine transformation as in the case of the conventional compressing process.

A calculated bit number controller 85 changes the number of bits in input and output data of the orthogonal transformer 82 in order to provide a degree of freedom sufficient to vary the calculation quality and processing speed. For example, if the calculation speed needs to be changed, the number of bits is reduced when a one-dimensional discrete cosine transformation result is input to a two-dimensional discrete cosine transforming process, which is to be executed next.

The DCT coefficients output by the orthogonal transformer 82 are then linearly quantized by a quantizer 83 using a quantization table 86 for which quantization steps are set. The DCT coefficients are further compressed by an entropy encoder 84 using an encoding table 87.

According to Patent Document 1, in controlling bit length, the number of data bits is changed when data is input to or output from the data transformation calculating section (orthogonal transformer 82) that executes discrete cosine transformation and the like. Patent Document 1 discloses the use of bit number control means for varying the number of bits in two-dimensional input data; for image data requiring two data transformations, the bit number control means variably controls the number of bits in output data from a one-dimensional discrete cosine transforming process, that is, the number of bits in input data to a two-dimensional discrete cosine transforming process.

However, the image compressing method described in Patent Document 1 allows the number of bits in data to be variably controlled only before the data is input to and after it is output from the orthogonal transformer. This disadvantageously prevents the calculation quality and processing time from being varied sufficiently freely.

### SUMMARY OF THE INVENTION

An object of the present invention is to increase calculation speed, while suppressing the degradation of images.

To achieve this object, the present invention provides a method of compressing image data, the method being characterized by comprising a transforming step of transforming the image data into data comprising frequency components, the transforming step varying a number of bits to be calculated in each frequency component, in association with calculation quality, calculation speed, or quantization speed.

The present invention can increase the calculation speed while suppressing the degradation of image quality, in compressive encoding of image data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1A is a diagram showing an example of a configuration that realizes a compressing method in accordance with Embodiment 1 of the present invention;

FIG. 1B is a diagram showing an example of selection of a DCT in accordance with Embodiment 1;

FIG. 2A is a diagram showing an example of a configuration that realizes a compressing method in accordance with Embodiment 2 of the present invention;

FIG. 2B is a diagram showing a quantization table that realizes a compressing method in accordance with Embodiment 2;

FIG. 2C is a diagram showing the compressing method in accordance with Embodiment 2, in association with the quantization table in FIG. 2B;

FIG. 3 is a diagram showing an example of a two-dimensional discrete cosine transformation;

FIG. 4 is a diagram showing an example of a Chen algorithm that operates fast;

FIG. 5 is a diagram showing an example of a Chen algorithm of the highest quality in which the number of output bits is 16 for eight frequency components;

FIG. 6 is a diagram showing an example of a Chen algorithm in which the number of output bits for two high frequency components is compressed to 8 bits;

FIG. 7 is a diagram showing an example of a Chen algorithm in which the number of output bits for four high frequency components is compressed to 8 bits;

FIG. 8 is a diagram showing an example of a Chen algorithm in which the number of output bits for six high frequency components is compressed to 8 bits;

FIG. 9 is a diagram showing an example of a Chen algorithm of the highest speed in which the number of output bits is 8 for all eight frequency components;

FIG. 10 is a diagram showing an example of a Chen algorithm in which the numbers of output bits for two high frequency components and for two low frequency components are each compressed to 8 bits;

FIG. 11 is a diagram showing an example of general configuration of a compressing process in conformity with a JPEG baseline process; and

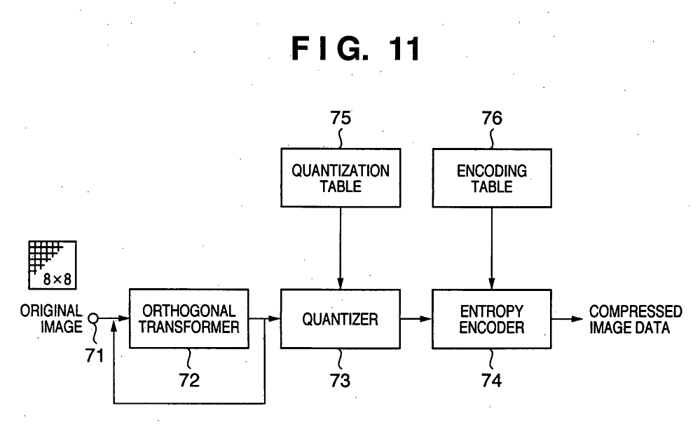

FIG. 12 is a diagram showing an example of general configuration of a compressing process of controlling quality by a bit line control process of controlling bit length.

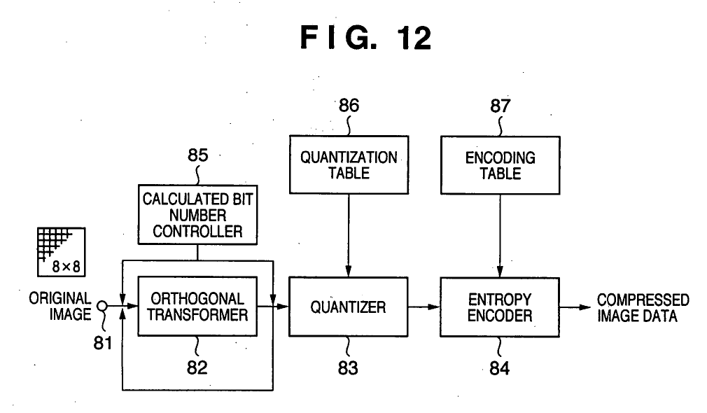

### DETAILED DESCRIPTION OF THE PREFERRED EMBODIMENTS

A method of compressing image data in accordance with the present invention includes a method of compressing and decompressing image data using orthogonal transformation. In particular, the use of a discrete cosine transforming process for an orthogonal transforming process in a JPEG compressing process improves calculation speed while suppressing the degradation of images. The discrete cosine transforming process can thus preferably be applied to the present invention.

The calculation speed can further be improved by using a processor capable of SIMD (Single Instruction Multiple Data) calculation to realize an encoding process in accordance with the present invention. That can thus preferably be applied to the present invention.

The present invention varies the number of bits used to calculate the product and sum of input data and frequency transformation coefficients, during the process of calculation executed inside an orthogonal transformer.

In the present embodiment, calculating processes executed inside the orthogonal transformer (DCT) will be described taking the case of a Chen algorithm that can operate fast. However, the present embodiment is not limited to this algorithm. For example, Fast Fourier. Transformation (FFT), digital signal processing for executing quantization process thereinafter or the like may be used for the calculating processes to produce similar effects.

The present embodiment will also be described in conjunction with a process of compressively encoding image data. However, the present embodiment is also applicable to an image input apparatus or an image communication apparatus such as a camera or a scanner into which the compressive encoding process is incorporated, an image output apparatus such as a printer, or a composite machine of these apparatuses. These apparatuses and systems are contained in the present invention.

### Example of an Orthogonal Transformation (Dct) Calculation for use in the Present Embodiment

### Example of a Calculation Procedure

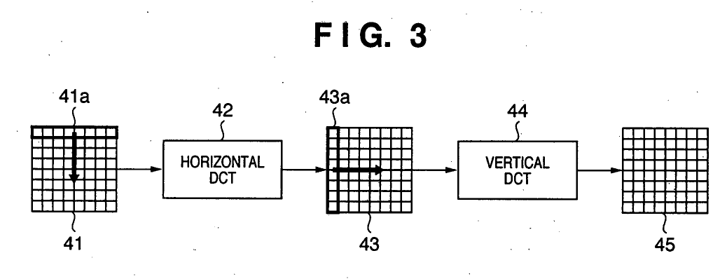

FIG. 3 is a diagram illustrating a calculation procedure used to transform 8×8 input image data into 8×8 frequency components in accordance with the present embodiment.

Input image data 41 is space data in which pixels are distributed in an 8×8 two-dimensional space. A one-dimensional discrete cosine transformation is executed on each row (see 41a) of the 8×8 block (horizontal DCT 42) to obtain a horizontal frequency transformation result 43. This intermediate result 43 is used to execute a one-dimensional discrete cosine transformation on each column (see 43a) of the 8×8 block, that is, a vertical frequency transformation (vertical DCT 44), to obtain two-dimensional DCT coefficients 45. If such a one-dimensional discrete cosine transformation is repeated, the results remain unchanged if the transformation of the rows is executed after the transformation of the columns.

### Example of a Calculating Process

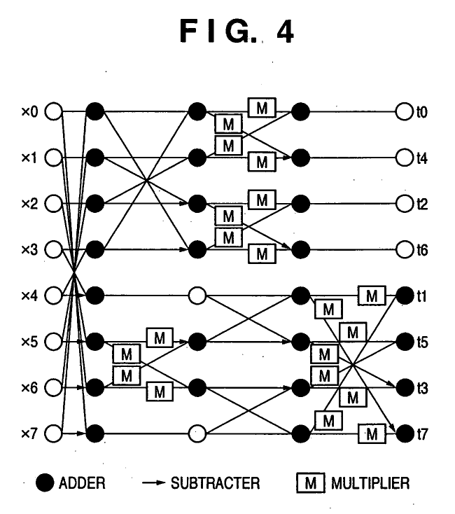

FIG. 4 is a diagram showing an example of the Chen algorithm, which operates fast, to execute a one-dimensional discrete cosine transformation on input image data that is space data to obtain frequency transformation coefficients.

Eight coefficients for one row of an original image block are input to input devices x0 to x7 located at the left end of the graph in FIG. 4. An addition or subtraction is executed at a point (black circle) where two paths cross. An addition is executed at each black circle without a subtraction indication (arrow). A subtraction is executed at each black circle with the subtraction indication (arrow). A multiplication (rectangle) by a certain constant is executed along some paths. Right-hand terminals t0 to t7 in FIG. 4 then output frequency transformation coefficients. A similar process is executed for the second and subsequent rows. Eight coefficients for one column of the 8×8 block subjected to the one-dimensional frequency conversion are input to the input device, which then executes a similar frequency conversion. A two-dimensional frequency transformation is thus executed.

For input data having 8-bit information, the range of the two-dimensional discrete cosine transformation output results is 10 bits. Consequently, to express the entire range using the Chen algorithm, a 16-bit frequency transformation coefficient is output.

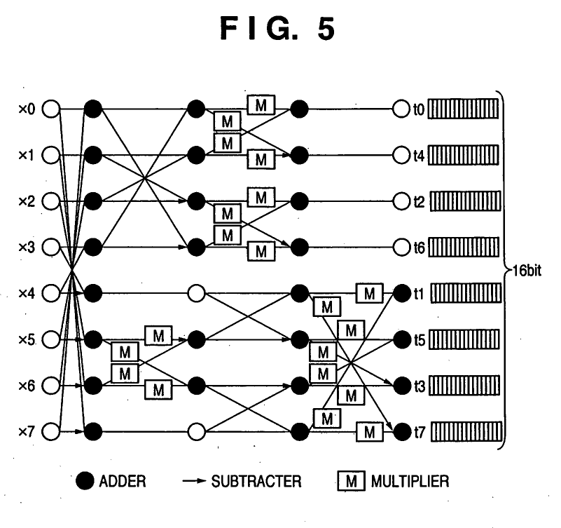

FIGS. 5 to 10 show various examples of a reduction in the number of output bits using the Chen algorithm.

FIG. 5 is a diagram showing an example of a Chen algorithm of the highest quality in which the number of output bits is 16 for eight frequency components.

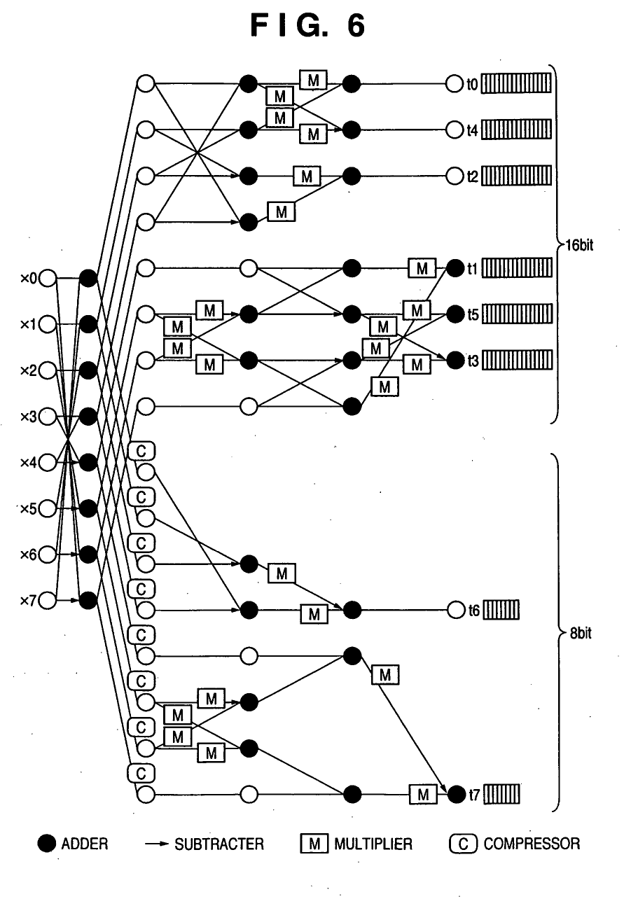

FIGS. 6 to 9 show reductions in the number of bits calculated to determine high-frequency components.

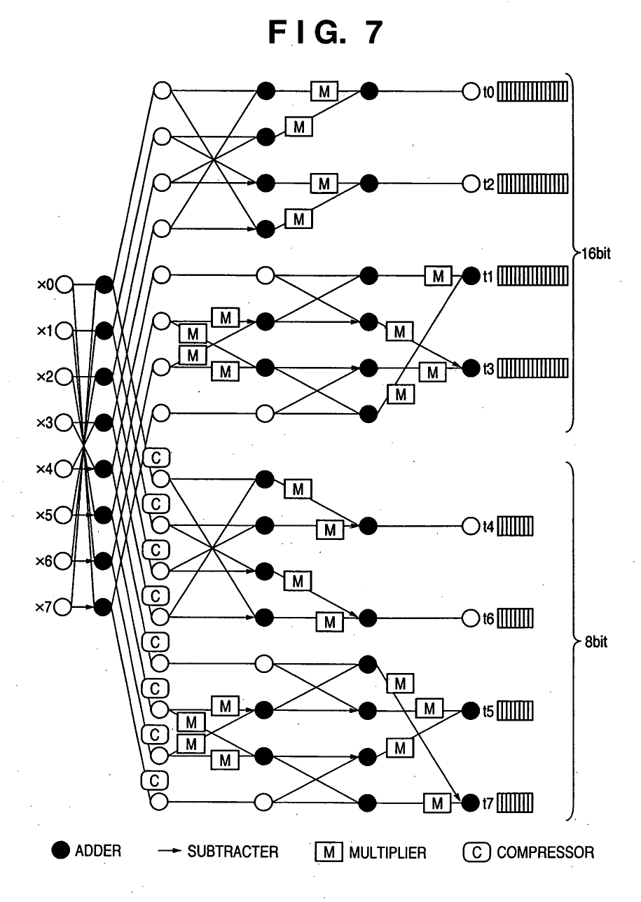

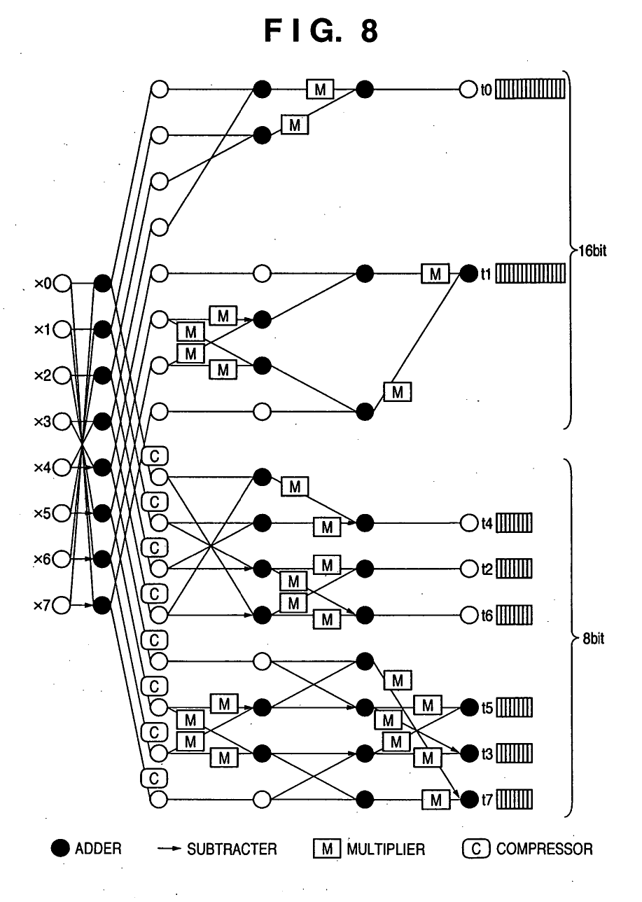

FIG. 6 is a diagram showing an example of a Chen algorithm in which the number of output bits for two high frequency components is compressed to 8 bits. FIG. 7 is a diagram showing an example of a Chen algorithm in which the number of output bits for four high frequency components is compressed to 8 bits. FIG. 8 is a diagram showing an example of a Chen algorithm in which the number of output bits for six high frequency components is compressed to 8 bits.

The realization methods shown in the graphs in FIGS. 6 to 8 improve the calculation speed compared to that shown in the graph in FIG. 5, in order of ascending figure number. However, owing to the degradation of the calculation quality, realization methods shown in the graphs in FIGS. 6 to 8 degrade image quality compared to that shown in the graph in FIG. 5, in order of ascending figure number. As described above, for input data having 8-bit information, the range of the two-dimensional discrete cosine transformation output results is 10 bits. This reduces the number of bits used for a part of the calculation to enable an increase in the calculation speed at which two-dimensional discrete cosine transformation output results are obtained for 8 bits.

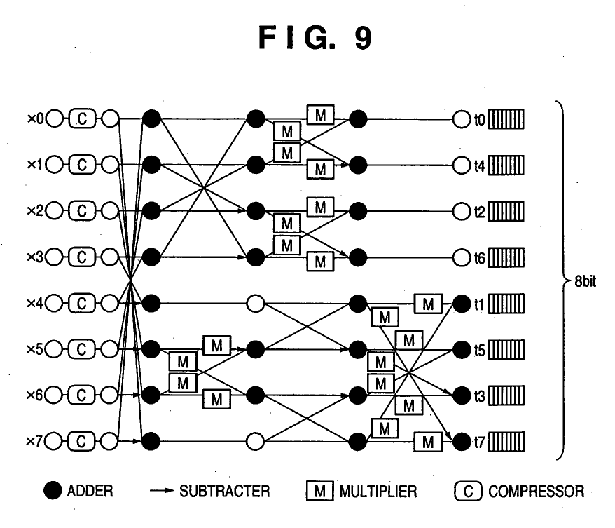

FIG. 9 shows an example of a Chen algorithm of the highest speed in which the number of output bits is 8 for all eight frequency components.

FIGS. 5 to 9 show examples in which 16 bits are compressed to 8 bits for every two high-frequency components. However, the compression can be executed for every frequency component.

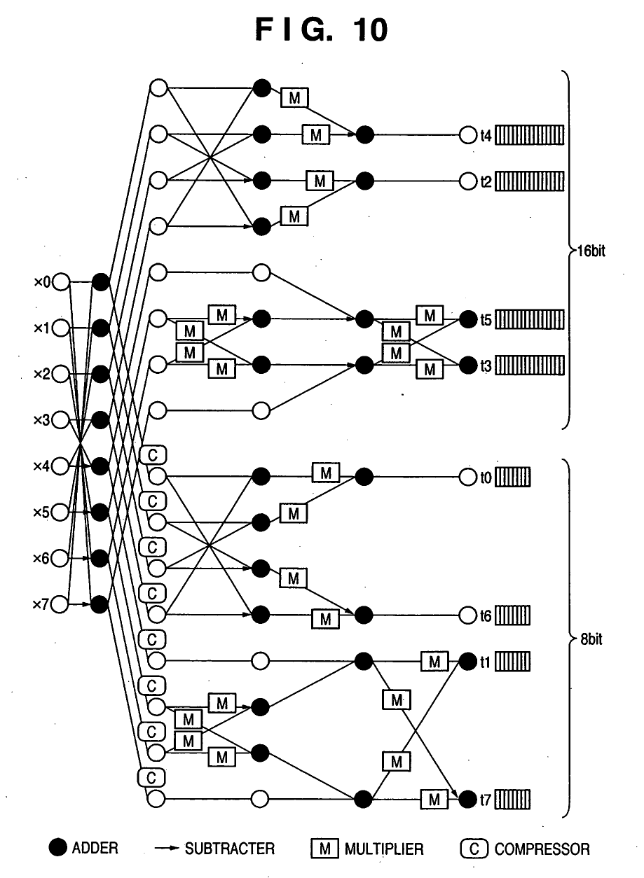

In another example of calculation, 16 bits are compressed to 8 bits for low and high-frequency components, whereas 16 bits are output as they are for middle-frequency components, instead of the reduction in the number of bits for high-frequency components as shown in FIG. 10. In another example of calculation, particular frequency components may be compressed or may not be compressed.

The number of bits in the transformation output result is not limited to the above example. The numbers of bits and compressed bits may be varied depending on image data to be calculated.

As described above, plural patterns of discrete cosine transformations are prepared which use a reduced number of bits for a part of the calculation and which vary the calculation quality and speed step by step as shown in FIGS. 5 to 10. This enables an orthogonal transforming process to be selected in accordance with a processing request or the subsequent encoding process.

An example of configuration of a preferred embodiment of the present invention will be described taking the case of the above orthogonal transformation (DCT) as an example.

### Embodiment 1

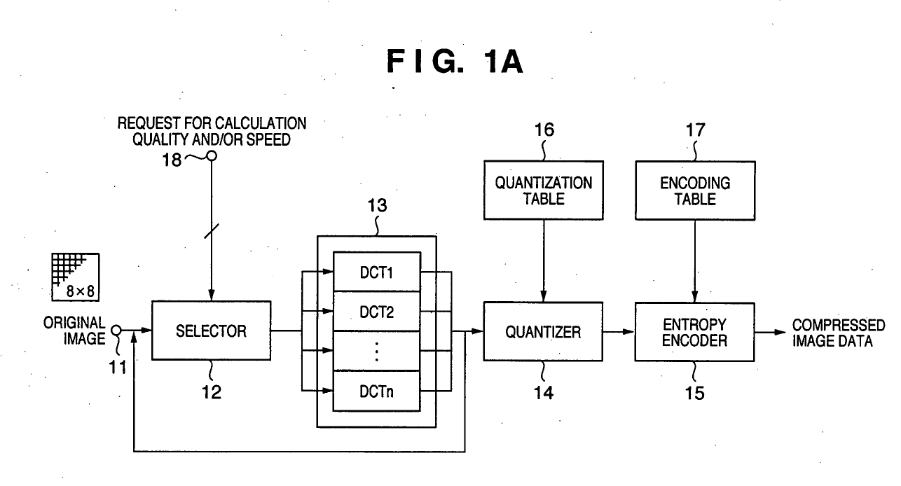

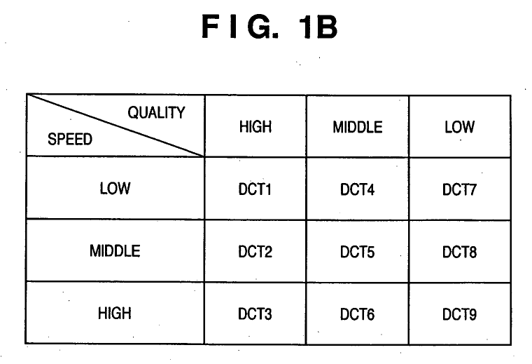

FIG. 1A is a diagram showing an example of configuration of Embodiment 1 that realizes a compressing method in accordance with the present invention. With reference to FIG. 1A, description will be given of a method of selecting from discrete cosine transformations (DCT) requiring different numbers of calculated bits.

In FIG. 1A, reference numeral 11 denotes an input device. Data input to the input device 11 is preferably input data used for a JPEG compressing process of dividing image data into blocks each composed of 8×8 pixels. A digital still image as input data is a collection of two-dimensionally distributed pixels. In the present example, each pixel consists of 8-bit information.

Reference numeral 12 denotes a selector. The selector 12 selects one of the DCT1 to DCTn in an orthogonal transformer 13 which corresponds to a calculation speed and calculation quality which meet a user's request. This makes it possible to improve the degree of freedom of orthogonal transformation calculation. The selector 12 selects, for each block, one of the plurality of discrete cosine transforming processes (DCT1 to DCTn) provided in the orthogonal transformer 13 which meets the user's request; the orthogonal transformer 13 follows the selector 12 in the circuit. That is, the selector 12 outputs original image data received from the preceding input device 11, to a target discrete cosine transforming section.

Reference numeral 18 denotes a request input device for calculation speed and quality requests. The request input device 18 transmits, for example, a request for selection from the DCT1 to DCTn for each 8×8 block of an input image. The selector 12 selects one of the DCT1 to DCTn in the orthogonal transformer 13 in accordance with the user's request.

The request input device 18 transmits a request for giving of priority to either the processing speed or calculation quality. That is, the user's request indicates which of the image quality (calculation quality) and processing speed is given priority and what priority is given to the selected one, for each block. For example, the selector 12 selects in accordance with user's request one of the DCT1 to DCTn so as to improve the quality of only a part of the image, while giving priority to the processing speed for the remaining part.

The orthogonal transformer 13 consists of n patterns of devices that use different numbers of bits for a fast discrete cosine transforming process. This enables the orthogonal transformation calculation to be executed more efficiently.

The orthogonal transformer 13 contains n patterns of calculating methods for discrete cosine transformation. The orthogonal transformer 13 receives two-dimensional input data from the selector 12. The orthogonal transformer 13 executes a two-dimensional discrete cosine transformation including a horizontal frequency transformation and a vertical frequency transformation and then outputs a DCT coefficient.

The plurality of discrete cosine transformations (DCT1 to DCTn) provided in the orthogonal transformer 13 are realized with different settings for the calculation quality and speed.

In the description of the present embodiment, the selector 12 and orthogonal transformer 13 are separate from each other. However, they can be realized as an integral orthogonal transformer including a group of DCTs and a selector that selects one of the DCTs and executes orthogonal transformation, on the basis of an input from the request input device 18.

Reference numeral 14 denotes a quantizer. The quantizer 14 executes quantization on the basis of a quantization table 16 in which arbitrary values are set. In particular, significant compression can be achieved while suppressing the degradation of the image, by setting the values such that the quantizer 14 sharply reduces high-frequency components.

Reference numeral 15 denotes an entropy encoder that can efficiently compress data particularly by using Haffman encoding to allocate signs on the basis of an encoding table 17.

(Plurality of Discrete Cosine Transformations and an Example of Selection)

The discrete cosine transformation involves a calculation algorithm called a fast realization method and requiring a reduced amount of calculation. In the example below, the DCT will be described taking the case of the Chen algorithm, which operates fast.

With reference to FIG. 1B and FIGS. 5 to 9, previously described, description will be given of the plurality of discrete cosine transformations in accordance with Embodiment 1 as well as an example of selection.

For example, in FIGS. 5 to 9, nine DCTs, DCT1 (16 bits for all output components) to DCT9 (8 bits for all output components), are assumed in which 16 bits are compressed to 8 bits for each frequency component.

FIG. 1B is a diagram showing an example of a selection table from which one of the DCT1 to DCT9 is selected on the basis of the calculation quality and speed input by the request input device 18.

In this example, the calculation quality and speed input by the request input device 18 are each expressed by 2 bits (four selections are possible). The calculation quality and speed may be input directly by the user or a user interface may be simplified using a table on the basis of which the calculation quality and speed are determined in response to an instruction from the user interface.

As shown in FIG. 1B, if a slow and high-quality calculation is requested, the DCT1 (corresponding to FIG. 5) is selected to output 16 bits for all frequency components. If a low-quality but fast calculation is requested, the DCT9 (corresponding to FIG. 9) is selected to output 8 bits for all frequency components.

In FIG. 1B, the DCT3 corresponds to FIG. 6, the DCT5 corresponds to FIG. 7, and the DCT7 corresponds to FIG. 8.

FIG. 1B shows an example in which one of the DCTs is selected with priority given to the calculation quality. If priority is given to the calculation speed, the DCT1 to DCT9 may be arranged across the row in FIG. 1B.

In the above description, for simplification, the DCT1 to DCT9 are associated with the respective Chen algorithms so that both horizontal and vertical DCTs use the same Chen algorithm. However, the horizontal and vertical DCTs of each DCT may use different Chen algorithms. The horizontal or-vertical DCT may be composed of a plurality of Chen algorithms.

In the present example, an example of the DCT is the Chen algorithm. However, any other algorithm can be used to produce similar effects provided that it can vary the calculation quality and speed step by step.

The above configuration enables the selection of an orthogonal transforming process in accordance with the user's request (corresponding to a “processing request” in accordance with the present invention) by preparing plural patterns of discrete cosine transformations in which the number of bits used for a part of the calculation is reduced and in which the calculation quality and speed are varied step by step.

### Embodiment 2

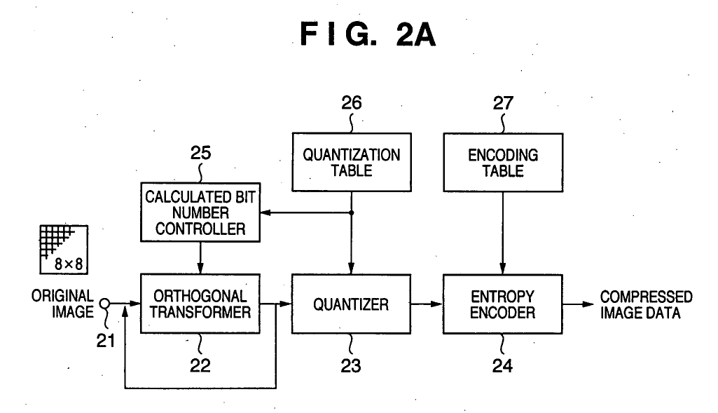

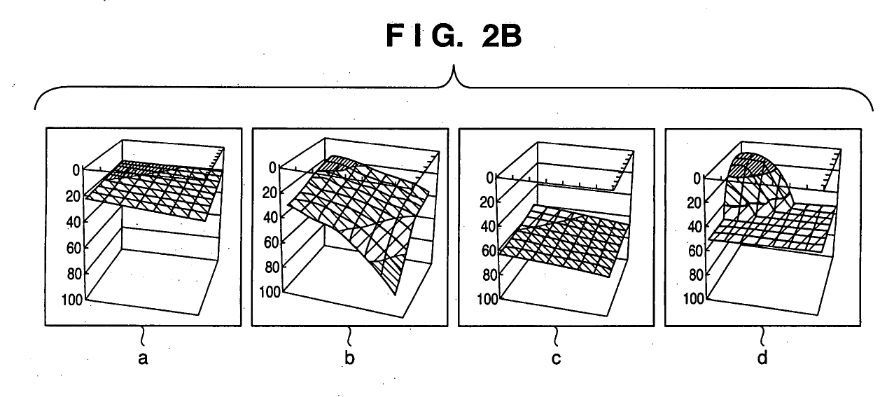

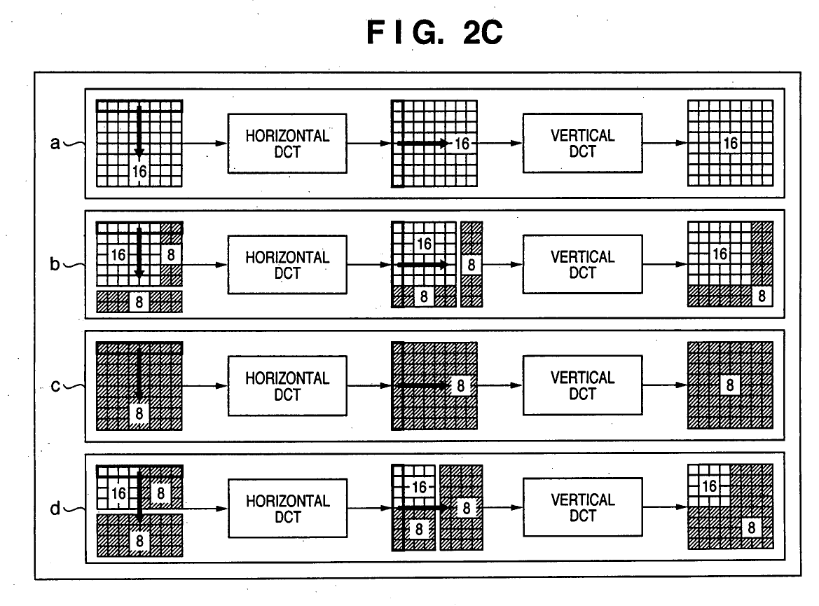

FIG. 2A is a diagram showing an example of configuration of Embodiment 2 that realizes the compressing method in accordance with the present invention. With reference to FIG. 2A, description will be given of a method of controlling the number of calculated bits using the values in the quantization table 26. In the present embodiment, the JPEG compressing process shown in FIG. 2A will be described. The basis compressing process is similar to that described in Embodiment 1. The JPEG compressing process in accordance with the present embodiment uses a processor for 64-bit calculation which is capable of SIMD calculation.

In FIG. 2A, reference numeral 21 denotes an input device. Data used for the JPED compressing process is preferably input to the input device 21; one block of the input data corresponds to 8×8 pixels in the image data. A digital still image as input data is a collection of two-dimensionally distributed pixels. Each pixel consists of 8-bit information.

Reference numeral 22 denotes an orthogonal transformer. The orthogonal transformer 22 is preferably a fast discrete cosine transformer that enables the orthogonal transformation calculation to be executed more efficiently. Further, the orthogonal transformer 22 is preferably realized by software that uses a 64-bit processor. This. enables calculation with a high degree of freedom.

The orthogonal transformer 22 executes a two-dimensional discrete cosine transformation on two-dimensional input data from the input device 21; the two-dimensional discrete cosine transformation includes a horizontal frequency transformation and a vertical frequency transformation. The orthogonal transformer 22 thus outputs DCT coefficients.

The orthogonal transformer 22 in the present example realizes frequency transformation using a 64-bit calculation processor capable of SIMD calculation. The 64-bit processor capable of SIMD calculation generally packs a plurality of 8- or 16-bit data into a data width of 64 bits and enables a single instruction to process all data at the same time.

The orthogonal transformer 22 allows a calculated bit number controller 25 to change the number of bits used for internal calculation, the number corresponding to a value in the quantization table 26.

In general, compared to input data having an 8-bit range, two-dimensional discrete cosine transformation output results have a 10-bit range. Thus, parallel calculation based on the 64-bit processor requires a 16-bit calculation to be carried out by 4 parallel processes. However, the number of parallel calculations can be increased by executing a process of reducing the number of calculated bits (“compressing” process shown in FIGS. 6 to 8), for the calculation contained in the two-dimensional discrete cosine transforming process. This increases the speed of the calculation. If all processes required to complete a calculation can be achieved using 8 bits as shown in FIG. 9, then the parallel calculation based on the 64-bit processor enables an 8-bit calculation to be realized by 8 parallel processes. This increases the calculation speed.

Thus, the orthogonal transformer 22 reduces the number of bits required for a part of the calculation which is significantly quantized by the succeeding quantizer 23. This improves the parallel nature of the calculation based on the 64-bit processor, thus increasing the calculation speed.

Reference numeral 23 denotes the quantizer that executes quantization on the basis of the quantization table 26, in which arbitrary values are set. In particular, by enabling the quantizer 23 to sharply reduce high frequency components, it is possible to achieve marked compression while suppressing the degradation of the image.

Reference numeral 24 denotes an entropy encoder (variable encoder). The entropy encoder 24 efficiently compress data particularly by using Haffman encoding to allocate signs on the basis of an encoding table 27.

Reference numeral 25 denotes a calculated bit number controller that enables a variation of the number of bits used for calculation of frequency components in the fast discrete cosine transforming process of the orthogonal transformer 22. The calculated bit number controller 25 uses information from the quantization table 26 to control calculated bits, which enables efficient calculations.

It is described as an example thereafter how to reduce the number of bits required for a part of the calculation based on the quantization table. In under table, correspondence between quantization values and the number of bits required for a part of the calculation can be altered properly.

| quantization values | |
|---|---|
| (16 bits maximaum) | a number of calculation bits |
| 1024˜ | 4 |
| 64˜1023 | 8 |
| 8˜63 | 12 |
| 1˜7 | 16 |

The calculated bit number controller 25 receives the quantization value from the quantizatin table and judges the quantization value (represented as QV) as following condition (where thresh levels are alterable preferably):

If 1=QV<7, Chan algorithm in which output data have. 16 bits at all frequency components in both horizontal and vertical DCT;

If 8=QV<63, a combination of different Chan algorithms in which output data have 16 bits at some frequency components and 8 bits at remaining components;

If 64=QV<1024, Chan algorithm in which output data have 8 bits at all frequency components in both horizontal and vertical DCT.

### Example of Control of the Quantization Table and the Number of Calculated Bits

FIG. 2B is a diagram showing an example of a quantization table in accordance with the present embodiment. FIG. 2C is a diagram showing the procedures of a horizontal and vertical DCTs used in the respective cases shown in FIG. 2B. In the present example, the Chen algorithms shown in FIGS. 5 to 9 are used for orthogonal transformations as they are or in combination.

A quantization table a in FIG. 2B shows that the amount of information reduced in the succeeding quantizing process is small all over the block. That is, quantization values are at the same level all over the block. This requires a frequency transformation to be executed by using a large number of calculated bits without degrading the quality. Accordingly, the Chen algorithm outputting 16 bits for all frequency components as shown in FIG. 5 Is used for both horizontal and vertical DCTs to execute an orthogonal transforming process in accordance with the procedure a in FIG. 2C.

A quantization table b in FIG. 2B shows that the succeeding quantizing process sharply reduces the amount of information in AC components included in the high frequency components. That is, the quantization values in the high frequency part are at only a few levels, thus reducing the amount of information. In a part with the amount of information significantly reduced, the quality is lowered to some degree and a small number of calculated bits are used. This increases the calculation speed. The Chen algorithm shown in FIG. 6 is thus used to reduce the number of bits calculated for high frequency components in an orthogonal transforming process.

The orthogonal transforming process may be executed by using the Chen algorithm shown in FIG. 6 for both horizontal and vertical DCTs. However, since, for two high frequency components, 8 bits are output for each row and for each column, the process can be achieved faster by using the Chen algorithm shown in FIG. 6 for the lowest frequency component to the sixth lowest frequency component, while using the Chen algorithm shown in FIG. 9 for the remaining two high frequency components, as shown in FIG. 2C b.

A quantization table c in FIG. 2B shows that the succeeding quantizing process sharply reduces the amount of information all over the block. That is, the quantization values all over the block are at only a few levels, thus reducing the amount of information. This allows the number of bits calculated in the entire orthogonal transforming process to be reduced to lower the calculation quality to some degree. Thus, the Chen algorithm outputting 8 bits for all frequency components as shown in FIG. 9 is used for both horizontal and vertical DCTs to execute an orthogonal transforming process in accordance with the procedure c shown in FIG. 2C. This enables the calculations to be executed in parallel to improve the processing speed.

A quantization table d in FIG. 2B shows that the quantizing process significantly reduces the amount of information in most high frequency components. The corresponding orthogonal transforming process is shown in d in FIG. 2C. A horizontal discrete cosine transformation uses the algorithm shown in FIG. 7 for the upper four rows, containing low frequencies, without degrading the calculation quality for the low frequency part. The algorithm shown in FIG. 9 is used for the lower four rows, containing no low frequencies, thus increasing the processing speed. A vertical discrete cosine transformation is similarly performed. Similar effects can be produced by using the algorithm shown in FIG. 7 for both horizontal and vertical DCTs. However, this increases the number of calculations to slightly reduce the processing speed.

The quantizer 23 executes a quantization calculation on image data converted into frequency components by the orthogonal transformer 22, in accordance with the values in the quantization table 26 described above. The entropy encoder 24 executes entropy encoding on an output from the guantizer 23 in accordance with the values in the entropy encoding table 27. The entropy encoder 24 then outputs data on the compressed image.

The user's request in accordance with Embodiment 1 can be incorporated into the configuration in accordance with Embodiment 2. In a configuration similar to that in accordance with Embodiment 2, the selector 12 selects values from the quantization table 26 in accordance with the user's request. The calculated bit number controller 25 receives the values selected from the quantization table 26. The calculated bit number controller 25 varies the number of bits calculated for frequency components in the fast discrete cosine transforming process of the orthogonal transformer 22 in accordance with the received values selected from the quantization table 26.

Alternatively, the selection based on the quantization table may be incorporated into the configuration in accordance with Embodiment 1. In a configuration similar to that in accordance with Embodiment 1, the selector 12 selects the orthogonal transformer 13 in accordance with the values of the quantization table.

Alternatively, Embodiments 1 and 2 may be added together so as to allow the selection based on the quantization table to be executed independently of the user's request. Alternatively, Embodiments 1 and 2 may be combined together so as to allow the selection of any of the values in the quantization table and of the number of calculated bits (or DCT) in accordance with the user's request for the calculation quality and speed.

According to the present invention, when an image signal is converted into a signal consisting of frequency components, the number of calculated bits is reduced in executing a calculation for frequency components that do not significantly affect the image quality. This increases the calculation speed, while suppressing the degradation of the image quality.

In the present embodiment, the configuration based on hardware is mainly described. However, clearly, all or part of the embodiment can be realized by software.

In this case, the object of the present invention is of course achieved by supplying the system or apparatus with recoding media on which software program codes realizing the functions of the above embodiments are recorded and allowing a computer (or CPU or MPU) in the system or apparatus to read and execute the program codes stored in the recording media. The program codes themselves read from the recording media realize the functions of the embodiments. The present invention is composed of the program codes themselves and the recording media on which the program codes are recorded.

Examples of recording media used to supply the program codes include a flexible disk, a hard disk, an optical disk, a magneto optic disk, a CD-ROM, a CD-R, a magnetic tape, a nonvolatile memory card, and a ROM.

The functions of the above first or second embodiment can of course be realized not only by executing the program codes read by the computer but also by allowing an OS or the like operating on the computer to execute all or a part of the actual processing on the basis of instructions in the program codes.

The functions of the above embodiments can of course be executed by writing the program codes read from the recording media to a memory provided in an expansion board inserted into the computer or an expansion unit connected to the computer and then allowing a CPU or the like provided in the expansion board or unit to execute all or a part of the actual processing on the basis of instructions in the program codes.

As many apparently widely different embodiments of the present invention can be made without departing from the spirit and scope thereof, it is to be understood that the invention is not limited to the specific embodiments thereof-except as defined in the appended claims.

This application claims the benefit of Japanese Application No. 2005-110190, filed on Apr. 6, 2005, which is hereby incorporated by reference herein in its entirety.

What is claimed is:

1. A method of compressing image data comprising a step of transforming image data into data composed of frequency components,
wherein, in said transforming step, a number of bits calculated for frequency components requiring relatively low calculation quality for a transforming process is reduced below a number of bits calculated for frequency components requiring relatively high calculation quality for the transforming process.

2. The method according to claim 1, wherein the calculation quality for the transforming process is judged to be relatively low for frequency components having a small number of significant bits in a calculation result and to be relatively high for frequency components having a large number of significant bits in a calculation result.

3. The method according to claim 2, wherein, in said transforming step, lower frequency components have more significant bits, the number of significant bits decreases with increasing frequency, and the number of bits calculated for frequency components decreases in order of descending frequency.

4. The method of according to claim 1, wherein said transforming step comprises a horizontal transforming step of executing a horizontal frequency transformation and a vertical transforming step of executing a vertical frequency transformation.

5. The method according to claim 1, wherein, in said transforming step, a plurality of Chen algorithms are used to realize data transformation in which a number of bits calculated is reduced for one or more selected frequency component.

6. The method according to claim 1, further comprising a step of receiving information indicating calculation quality and/or calculation speed in said transforming step,
wherein, in said transforming step, a number of frequency components for which a number of calculated bits is reduced is controlled on the basis of the information indicating the calculation quality and/or calculation speed received in said receiving step.

7. The method according to claim 6, wherein, in said transforming step, the data transformation is executed by a transformation processing unit which is selected from a plurality of transformation processing units having different calculation qualities and/or calculation speeds on the basis of the information indicating the calculation quality and/or calculation speed received in said receiving step.

8. The method according to claim 1, further comprising a step of quantizing data composed of the frequency components transformed in said transforming step, using quantization values , and
wherein said transforming step comprises a step of detecting a number of quantization values for each of frequency components to change the number of bits calculated for the frequency component quantized using the quantization values, depending on the number of the quantization values detected in said detecting step.

9. The method according to claim 1, wherein, in said transforming step, the data transformation is realized by selecting a combination of algorithms which minimizes the number of calculated bits from a plurality of Chen algorithms and using a processor capable of a parallel calculating process corresponding to the minimized number of calculated bits.

10. A compressing apparatus for compressing image data comprising:
an image input unit adapted to input image data in a unit of block; and
a transforming unit adapted to transform the input image data into data composed of frequency components,
wherein said transforming unit reduces a number of bits calculated for frequency components requiring relatively low calculation quality for a transforming process below a number of bits calculated for frequency components requiring relatively high calculation quality for the transforming process.

11. The apparatus according to claim 10, wherein the calculation quality in the transforming process is relatively low for high frequency components having a small number of significant bits in a calculation result and is relatively high for low frequency components having a large number of significant bits in a calculation result, and
said transforming unit reduces a number of bits calculated for frequency components in order of descending frequency.

12. The apparatus according to claim 10, wherein said transforming unit comprises a horizontal transforming unit that executes a horizontal frequency transformation and a vertical transforming unit that executes a vertical frequency transformation.

13. The apparatus according to claim 10, wherein said transforming unit comprises a plurality of different Chen algorithm units to realize a data transformation that reduces a number of bits calculated for a selected frequency component.

14. The apparatus according to claim 10, further comprising an instruction input unit adapted to input information indicating calculation quality and/or calculation speed of said transforming unit, and
wherein said transforming unit controls a number of frequency components for which a number of calculated bits is reduced, on the basis of the information indicating the calculation quality and/or calculation speed input via said instruction input unit.

15. The apparatus according to claim 14, wherein said transforming units executes the data transformation using a transformation processing unit which is selected from a plurality of transformation processing units having different calculation qualities and/or calculation speeds on the basis of the information indicating the calculation quality and/or calculation speed input via said instruction input unit.

16. The apparatus according to claim 10, further comprising a quantizing unit adapted to quantizing data composed of frequency components transformed by said transforming unit using quantization values, and
wherein said transforming unit comprises a detecting means adapted to detect a number of the quantization values for each of frequency components to change the number of bits calculated for the frequency component quantized using the quantization values, depending on the number of the quantization values detected by said detecting means.

17. The apparatus according to claim 10, wherein said transforming unit realizes the data transformation by selecting a combination of algorithms which minimizes the number of calculated bits from a plurality of Chen algorithms and using a processor capable of a parallel calculating process corresponding to the minimized number of calculated bits.

18. A computer executable compression program for compressing image data, comprising a step of transforming input image data into data composed of frequency components,
wherein, in said transforming step, a number of bits calculated for frequency components requiring relatively low calculation quality for a transforming process is reduced below a number of bits calculated. for frequency components requiring relatively high calculation quality for the transforming process.

19. A computer readable storage medium in which a computer executable compression program for compressing image data is stored, said compression program comprising a step of transforming input image data into data composed of frequency components,
wherein, in said transforming step, a number of bits calculated for frequency components requiring relatively low calculation quality for a transforming process is reduced below a number of bits calculated for frequency components requiring relatively high calculation quality for the transforming process.
